(19) United States
(12) Patent Application Publication
(10) Pub. No.: US 2022/0131121 A1
(43) Pub. Date: Apr. 28, 2022

(54) BATTERY SYSTEM WITH INTERNAL BATTERY TERMINAL(S)

(71) Applicant: Raytheon Company, Waltham, MA (US)

(72) Inventors: Joseph P. Dylla, Oro Valley, AZ (US); Arturo D. Hernandez, Tucson, AZ (US); Jacob Grendahl, Tucson, AZ (US); Tommy H. Canez, JR., Tucson, AZ (US)

(21) Appl. No.: 17/077,736

(22) Filed: Oct. 22, 2020

(51) Int. Cl. H01M 2/30; H01M 2/10

(52) U.S. Cl. CPC H01M 2/305; H01M 2/1077

(57) ABSTRACT

A battery system is provided that includes a battery case, a battery header, a first terminal and a second terminal. The battery case is configured with an internal cavity. The battery header is attached to the battery case and encloses the internal cavity. The battery header includes a first terminal aperture and a second terminal aperture. The first terminal is connected to the battery header and arranged within the first terminal aperture. The first terminal is configured with a first receptacle aperture. The second terminal is connected to the battery header and arranged within the second terminal aperture. The second terminal is configured with a second receptacle aperture.

### BACKGROUND OF THE DISCLOSURE

### 1. Technical Field

This disclosure relates generally to a battery system and, more particularly, to an assembly for electrically coupling a battery and an electrical harness.

### 2. Background Information

A typical battery includes one or more battery cells arranged within a battery housing. A plurality of external battery terminals are electrically coupled to the battery cells. Each of these external battery terminals projects out from an exterior of the battery housing. The external battery terminals are arranged for mating with an electrical harness outside of the battery. While such a battery with external battery terminals has various advantages, there is still room in the art for improvement. For example, typical external battery terminals may increase space/packaging size requirements for the battery. Typical external battery terminals may also be susceptible to damage. There is a need in the art therefore for a battery with improved terminals which can reduce battery package size and/or reduce susceptibility of the terminals to damage.

### SUMMARY OF THE DISCLOSURE

According to an aspect of the present disclosure, a battery system is provided that includes a battery case, a battery header, a first terminal and a second terminal. The battery case is configured with an internal cavity. The battery header is attached to the battery case and encloses the internal cavity. The battery header includes a first terminal aperture and a second terminal aperture. The first terminal is connected to the battery header and arranged within the first terminal aperture. The first terminal is configured with a first receptacle aperture. The second terminal is connected to the battery header and arranged within the second terminal aperture. The second terminal is configured with a second receptacle aperture.

According to another aspect of the present disclosure, another battery system is provided that includes a battery case, a battery header, a first terminal and one or more battery cells. The battery case is configured with an internal cavity. The battery header is attached to the battery case and encloses the internal cavity. The battery header includes a first terminal aperture. The first terminal is connected to the battery header and arranged within the first terminal aperture. The first terminal is configured with a blind first receptacle aperture. The one or more battery cells are arranged within the internal cavity. Each of the one or more battery cells includes a cathode, an anode and electrolytic material. The first terminal is electrically coupled to the cathode or the anode of at least one of the one or more battery cells.

According to still another aspect of the present disclosure, another battery system is provided that includes a battery, a plug and a fastener. The battery includes a first terminal configured with a first receptacle aperture. The plug includes a first pin. The first pin projects into the first receptacle aperture and is electrically coupled with the first terminal. The fastener secures the plug to the battery.

The battery may also include a second terminal configured with a second receptacle aperture. The plug may also include a second pin. The second pin may project into the second receptacle aperture and may be electrically coupled with the second terminal.

The battery system may also include a second terminal connected to the battery header and arranged within a second terminal aperture in the battery header. The second terminal may be configured with a blind second receptacle aperture.

The battery system may also include a plug and a fastener. The plug may include a first pin that projects into the blind first receptacle aperture and is electrically coupled with the first terminal. The fastener may removably secure the plug to the battery header.

The first terminal may project through the first terminal aperture and into the internal cavity.

The first receptacle aperture may be configured as or otherwise include a blind, smooth-walled bore.

The first receptacle aperture may extend partially into the first terminal from an exterior surface of the first terminal towards the internal cavity.

The battery system may also include a first insulator arranged within the first terminal aperture between the battery header and the first terminal. The first insulator may electrically isolate the first terminal from the battery header.

The first terminal may extend longitudinally between an exterior end and an interior end. The first terminal may include a base and a rim. The base may be arranged within the first terminal aperture. The base may extend longitudinally from the exterior end towards the interior end. The rim may be connected to and circumscribe the base at the exterior end. The rim may be seated against the first insulator. The first receptacle aperture may extend from the exterior end partially into the base towards the interior end.

A threaded fastener aperture may extend partially into the battery header from an exterior surface of the battery header.

The battery header may include a boss that surrounds the threaded fastener aperture. An exterior surface of the first terminal may be flush with or recessed from an exterior surface of the boss.

The battery system may also include a plurality of battery cells arranged within the internal cavity. Each of the battery cells may include an anode, a cathode and electrolytic material. The first terminal may be electrically coupled to the anode of at least one of the battery cells. The second terminal may be electrically coupled to the cathode of at least one of the battery cells.

The battery system may also include a plug. The plug may include a first pin and a second pin. The first pin may project into the first receptacle aperture and may be electrically coupled with the first terminal. The second pin may project into the second receptacle aperture and may be electrically coupled with the second terminal.

The battery system may also include a fastener removably securing the plug to the battery header.

The battery system may also include an alignment feature configured to mate with an alignment aperture to align the plug with the battery header. The alignment feature may be configured with the plug or the battery header.

The plug may also include a first coil spring wrapped around the first pin. The first coil spring may be between and may electrically couple the first pin and the first terminal.

The first coil spring may be seated within a groove in the first pin.

The battery system may also include a third terminal connected to the battery header and arranged within a third terminal aperture in the battery header. The third terminal may be configured with a third receptacle aperture. A center of the first terminal and a center of the second terminal may be arranged along and aligned with a circumferential reference line. A center of the third terminal may be arranged along and offset from the circumferential reference line.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of a battery system configured for powering an electrically powered device.

FIG. 2 is a perspective side cutaway illustration of a battery.

FIG. 3 is an end view illustration of a battery header.

FIG. 4 is a side sectional illustration of a portion of the battery header taken along line 4-4 in FIG. 3.

FIG. 5 is a side sectional illustration of a portion of the battery header taken along line 5-5 in FIG. 3.

FIG. 6 is a side sectional illustration of a battery terminal taken along line 6-6 in FIG. 7.

FIG. 7 is an end view illustration of the battery terminal.

FIG. 8 is a side sectional illustration of a terminal isolator taken along line 8-8 in FIG. 9.

FIG. 9 is an end view illustration of the terminal isolator.

FIG. 10 is a perspective side cutaway illustration of an end portion of the battery.

FIG. 11 is a perspective side cutaway illustration of another battery.

FIG. 12 is an exploded view perspective illustration of a plug configured with a plurality of fasteners.

FIG. 13 is a perspective cutaway illustration of the plug.

FIG. 14 is a perspective cutaway illustration of a portion of the plug.

FIG. 15 is a perspective cutaway illustration of a portion of the battery system.

FIG. 16 is an exploded view perspective illustration of a portion of the battery system configured with an alignment feature.

FIG. 17 is an end view illustration of the battery configured with symmetrical battery terminals.

FIG. 18 is an end view illustration of the battery configured with asymmetrical battery terminals.

### DETAILED DESCRIPTION

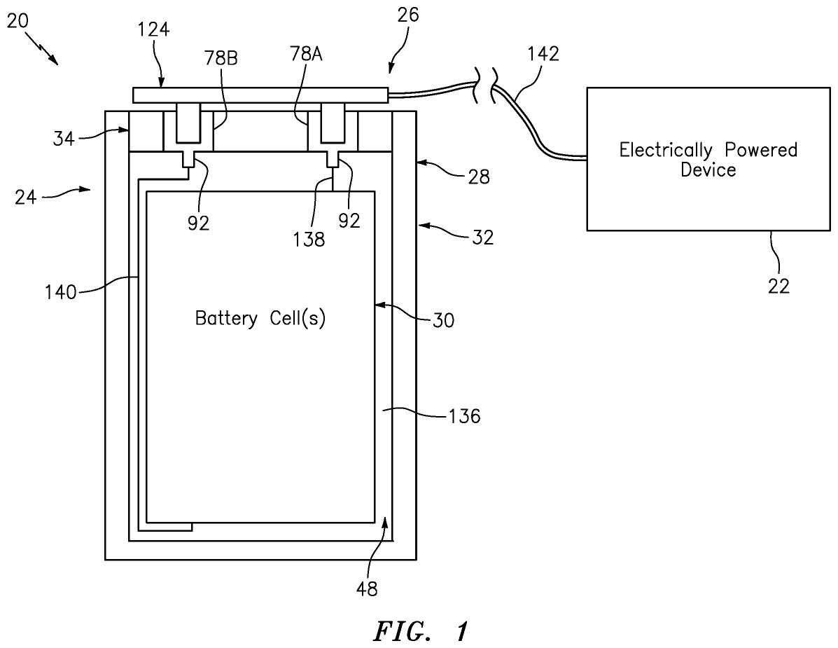

FIG. 1 illustrates a battery system 20 configured for powering an electrically powered device 22. The electrically powered device 22 may be configured as any type of device that uses electricity for operation. The electrically powered device 22, for example, may be configured as a piece of electronics, an actuator and/or a motor in a mobile device. Examples of a mobile device include, but are not limited to, an unmanned aerial vehicle (UAV), a drone or any other manned or unmanned aircraft or self-propelled projectile. The present disclosure, of course, is not limited to the foregoing exemplary mobile devices nor to mobile device applications. The battery system 20, for example, may alternatively be used in stationary power applications.

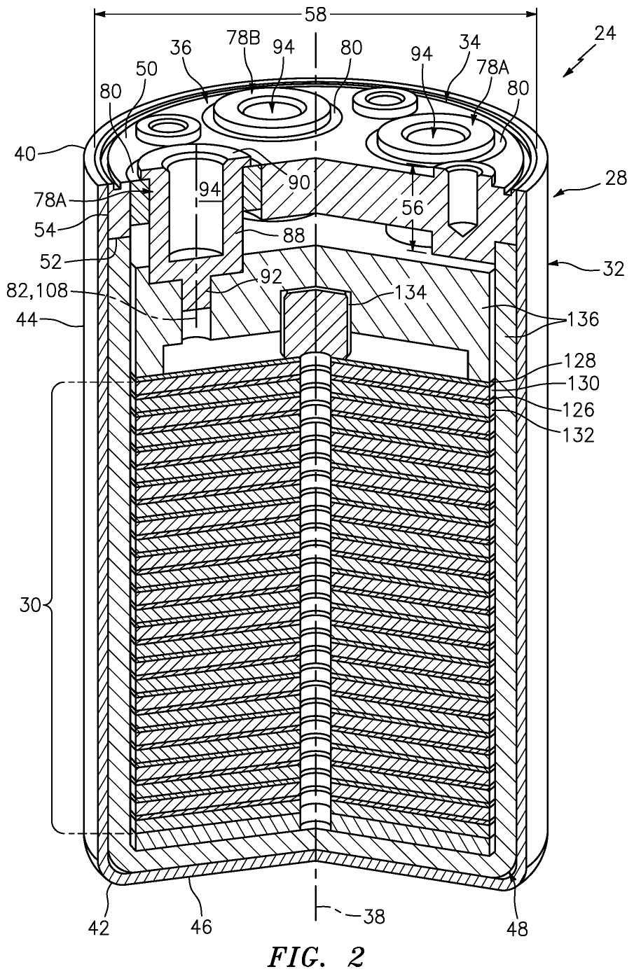

The battery system 20 of FIG. 1 includes a battery 24 and an electrical harness 26 for electrically coupling the battery 24 to the electrically powered device 22. Referring to FIG. 2, the battery 24 includes a battery housing 28 and one or more battery cells 30. The battery housing 28 includes a battery case 32, a battery header 34 and a battery terminal assembly 36.

The battery case 32 of FIG. 2 extends longitudinally along a longitudinal centerline 38 of the battery 24 between a first end 40 (e.g., a top end) of the battery case 32 and a second end 42 (e.g., a bottom end) of the battery case 32. The battery case 32 includes a tubular sidewall 44 and an end wall 46. The tubular sidewall 44 extends circumferentially about (e.g., completely around) the longitudinal centerline 38. The tubular sidewall 44 extends longitudinally along the longitudinal centerline 38 from the battery case first end 40 to the end wall 46. The end wall 46 is arranged at (e.g., on, adjacent or proximate) the battery case second end 42, and the end wall 46 is connected to the tubular sidewall 44. The end wall 46 is configured to close off and seal one end of the tubular sidewall 44. The tubular sidewall 44 and the end wall 46 may thereby collectively form an internal cavity 48 within the battery case 32; e.g., a bore that extends within the tubular sidewall 44 to the end wall 46.

The battery case 32 and its tubular sidewall 44 may be configured with a cylindrical geometry as shown in FIG. 2. The tubular sidewall 44 of FIG. 2, for example, has a circular cross-sectional geometry when viewed, for example, in a plane perpendicular to the longitudinal centerline 38. The present disclosure, however, is not limited to such an exemplary cylindrical configuration. For example, in other embodiments, the tubular sidewall 44 may have a non-circular cross-sectional geometry when viewed, for example, in a plane perpendicular to the longitudinal centerline 38. Examples of a non-circular cross-sectional geometry include, but are not limited to, an oval cross-sectional geometry, a racetrack shaped cross-sectional geometry, a square cross-sectional geometry, a rectangular cross-sectional geometry and a polygonal cross-sectional geometry. Furthermore, while the tubular sidewall 44 of FIG. 2 has a substantially uniform cross-sectional geometry along the longitudinal centerline 38, the present disclosure is not limited thereto. For example, the dimensions and/or the shape of the battery case 32 and its tubular sidewall 44 may alternatively change as the battery case 32 extends along the longitudinal centerline 38 in order to meet certain packaging requirements.

The battery case 32 may be constructed from metal. The battery case 32, for example, may be constructed from a metal alloy such as, but not limited to, steel (e.g., 304 L stainless steel) or titanium (Ti) alloy (e.g., titanium grade 5). The present disclosure, however, is not limited to the foregoing exemplary battery case materials.

The battery header 34 is configured as a lid and/or a plug for an open end of the battery case 32. The battery header 34 is also configured to provide a base for mounting the battery terminal assembly 36 with the battery 24.

The battery header 34 of FIG. 2 extends longitudinally along the longitudinal centerline 38 between a first end 50 (e.g., a top, exterior end) of the battery header 34 and a second end 52 (e.g., a bottom, interior end) of the battery header 34. The battery header 34 has a (e.g., cylindrical) outer surface 54. The battery header 34 extends radially out from the longitudinal centerline 38 to its outer surface 54. A longitudinal thickness 56 of the battery header 34 may be (e.g., significantly) less than a lateral width 58 (e.g., diameter) of the battery header 34. The battery header 34 may thereby have a disk and/or circular plate shaped body.

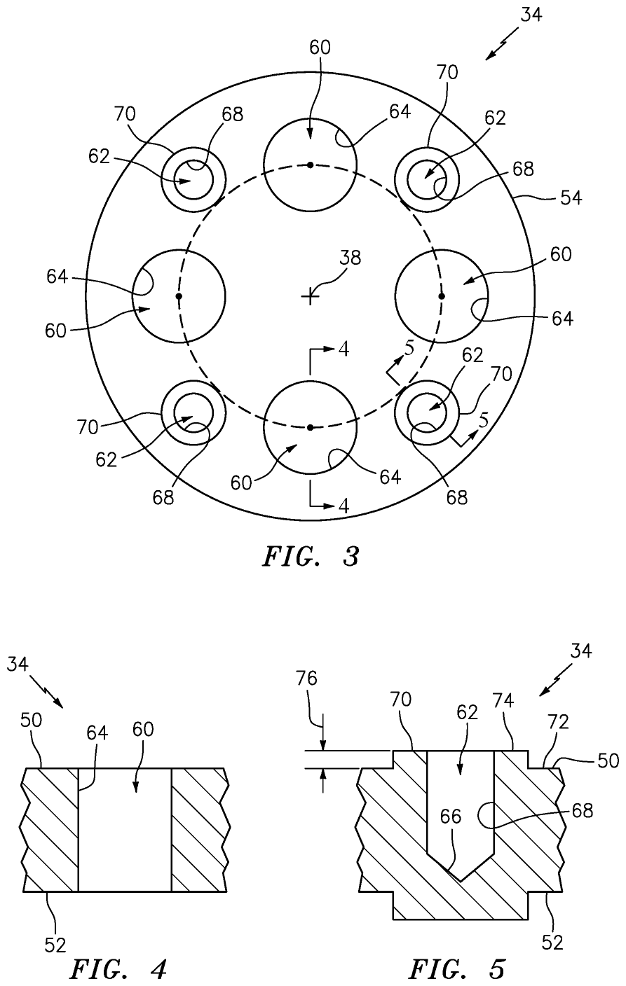

Referring to FIG. 3, the battery header 34 is configured with one or more terminal apertures 60. The battery header 34 of FIG. 3 is also configured with one or more mounting apertures 62.

The terminal apertures 60 of FIG. 3 are arranged (e.g., symmetrically and/or equispaced) about the longitudinal centerline 38 in an annular array. Similarly, the mounting apertures 62 of FIG. 3 are arranged (e.g., symmetrically and/or equispaced) about the longitudinal centerline 38 in an annular array. Each mounting aperture 62 may be disposed laterally (e.g., circumferentially) between a laterally neighboring (e.g., circumferentially adjacent) pair of the terminal apertures 60. Similarly, each of the terminal apertures 60 may be disposed laterally (e.g., circumferentially) between a laterally neighboring (e.g., circumferentially adjacent) pair of the mounting apertures 62. The mounting apertures 62 may thereby be interspersed with the terminal apertures 60. The present disclosure, however, is not limited to such an exemplary symmetrical arrangement of terminal apertures 60 and mounting apertures 62. Furthermore, while the battery header 34 of FIG. 3 includes the same number of terminal apertures 60 as mounting apertures 62, the battery header 34 may alternatively include a greater number of the terminal apertures 60 than the mounting apertures 62, or a greater number of the mounting apertures 62 than the terminal apertures 60.

Referring to FIG. 4, each of the terminal apertures 60 is configured as a through-hole. Each terminal aperture 60, for example, extends longitudinally through the battery header 34 from the battery header first end 50 to the battery header second end 52. Referring to FIG. 3, each terminal aperture 60 may be formed by a respective (e.g., smooth and/or cylindrical) surface 64 of the battery header 34.

Referring to FIG. 5, each of the mounting apertures 62 is configured as a blind, fastener aperture; e.g., a blind, threaded hole. Each mounting aperture 62, for example, extends partially longitudinally into the battery header 34 from the battery header first end 50 to a closed aperture end 66. Referring to FIG. 3, each mounting aperture 62 may be formed by a respective (e.g., generally cylindrical) threaded surface 68 of the battery header 34.

Referring to FIGS. 3 and 5, each of the mounting apertures 62 may be at least partially formed and/or surrounded by a mounting boss 70. This mounting boss 70 is arranged at the battery header first end 50. The mounting boss 70 projects out from an exterior surface 72 of the battery header 34 at the battery header first end 50 to an exterior surface 74 of the mounting boss 70 at a distal end of that respective mounting boss 70. The mounting boss exterior surface 74 is thereby longitudinally displaced from the battery header exterior surface 72 by a first longitudinal distance 76; see FIG. 5.

The battery header 34 may be constructed from metal. The battery header 34, for example, may be constructed from a metal alloy such as, but not limited to, steel (e.g., 304 L stainless steel) or titanium (Ti) alloy (e.g., titanium grade 5). The present disclosure, however, is not limited to the foregoing exemplary battery header materials.

Referring to FIG. 2, the battery header 34 is arranged with the battery case 32 in such a manner so as to close off and seal the open end of the battery case 32. The battery header 34 of FIG. 2, for example, is inserted (e.g., completely or partially) into the open end of the battery case 32. The battery header 34 is then bonded (e.g., welded, brazed, adhered, etc.) and/or otherwise attached to the battery case 32 and its tubular sidewall 44 at (e.g., on, adjacent or proximate) the battery case first end 40. The battery header 34 thereby encloses the internal cavity 48 of the battery case 32.

The battery terminal assembly 36 includes one or more battery terminals 78A and 78B (generally referred to as “78”). The battery terminal assembly 36 of FIG. 2 also includes one or more battery terminal isolators 80.

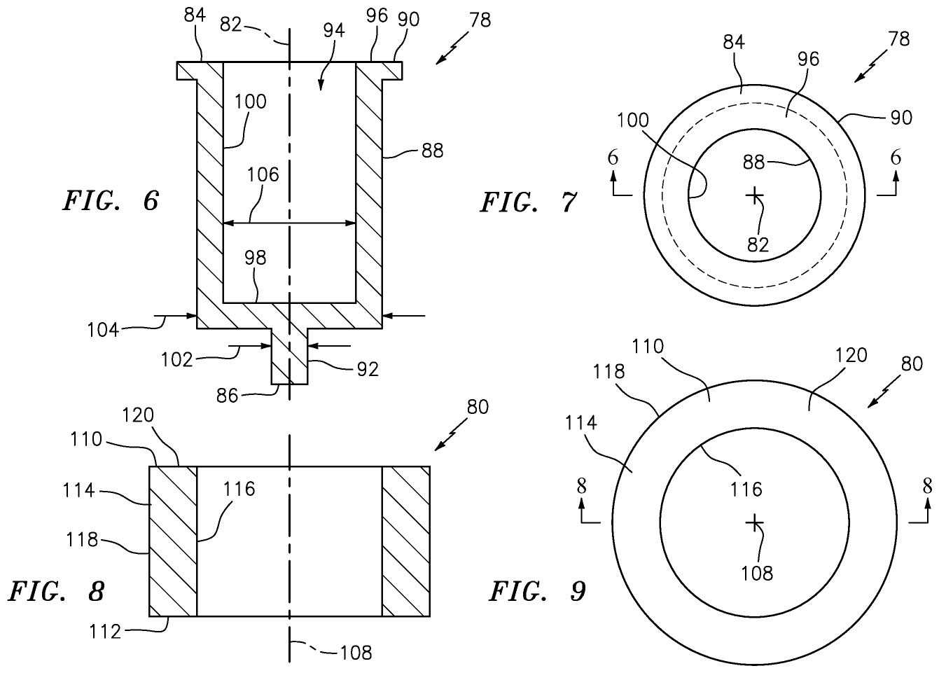

Referring to FIG. 6, each battery terminal 78 extends along a battery terminal centerline 82 between a first end 84 (e.g., top, exterior end) of the respective battery terminal 78 and a second end 86 (e.g., bottom, interior end) of the respective battery terminal 78. This battery terminal centerline 82 may be parallel with the longitudinal centerline 38 as shown in FIG. 2; however, the present disclosure is not limited thereto.

The battery terminal 78 of FIG. 6 includes a terminal base 88 and a terminal rim 90. The battery terminal 78 of FIG. 6 also includes a terminal lead 92 (e.g., a tab).

The terminal base 88 extends (e.g., longitudinally) along the battery terminal centerline 82 from the terminal first end 84 towards the terminal second end 86. The terminal base 88 is configured with a battery terminal receptacle aperture 94. This receptacle aperture 94 may be a blind, smooth-walled bore that extends partially into the terminal base 88 from an exterior surface 96 at the terminal first end 84 to a closed aperture end 98 towards/proximate the terminal second end 86. Referring to FIG. 7, the receptacle aperture 94 may be formed by a (e.g., smooth and/or cylindrical) surface 100 of the terminal base 88.

The terminal rim 90 is arranged at (e.g., on, adjacent or proximate) the terminal first end 84. The terminal rim 90 is connected to the terminal base 88. The terminal rim 90 projects radially out from an exterior of the terminal base 88 to a radial distal end of the terminal rim 90. The terminal rim 90 extends circumferentially around and thereby circumscribes the terminal base 88.

Referring to FIG. 6, the terminal lead 92 is arranged at the terminal second end 86. The terminal lead 92 is connected to an end wall portion of the terminal base 88. The terminal lead 92 projects (e.g., longitudinally) out from the terminal base 88 and its end wall portion to a longitudinal distal end of the terminal lead 92. The terminal lead 92 of FIG. 6 has a lateral width 102 (e.g., a diameter) that is less than a lateral width 104 (e.g., a diameter) of the terminal base 88 and/or less than a lateral width 106 (e.g., a diameter) of the terminal receptacle aperture 94. The present disclosure, however, is not limited to such an exemplary dimensional relationship.

Each battery terminal 78 may be constructed from an electrically conductive material such as, but not limited to, metal. Each battery terminal 78, for example, may be constructed from a metal alloy such as, but not limited to, nickel (Ni) alloy. The present disclosure, however, is not limited to the foregoing exemplary battery terminal materials.

Referring to FIG. 8, each terminal isolator 80 extends along an isolator centerline 108 between a first end 110 (e.g., top, exterior end) of the respective terminal isolator 80 and a second end 112 (e.g., bottom, interior end) of the respective terminal isolator 80. This isolator centerline 108 may be parallel with the longitudinal centerline 38 as shown in FIG. 2. The isolator centerline 108 may also or alternatively be parallel and/or colinear with a respective battery terminal centerline 82 as shown in FIG. 2; however, the present disclosure is not limited thereto.

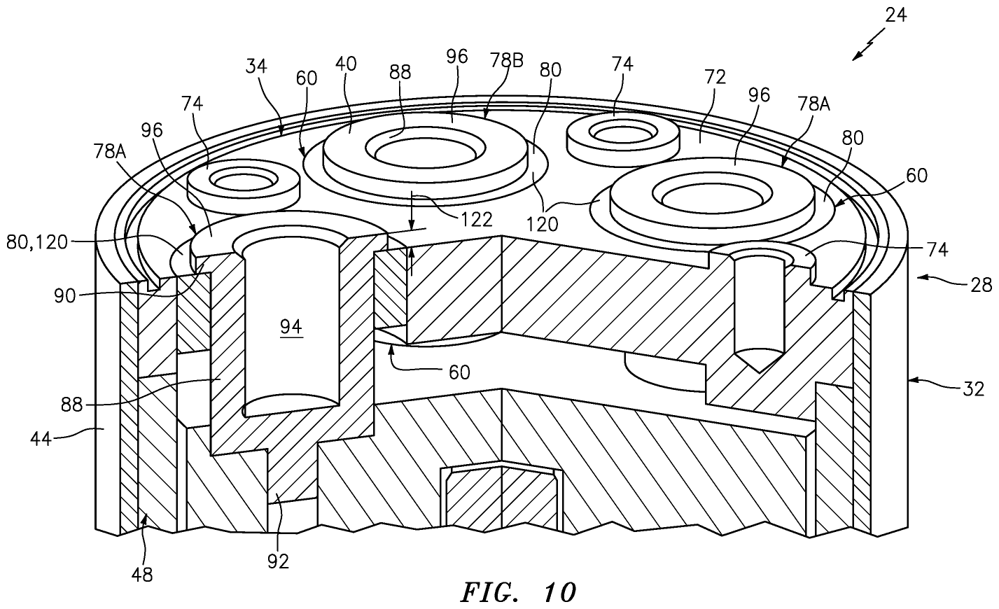

Referring to FIG. 9, each terminal isolator 80 has a tubular isolator sidewall 114. The isolator sidewall 114 extends circumferentially about (e.g., completely around) the isolator centerline 108. The isolator sidewall 114 extends radially from an (e.g., smooth and/or cylindrical) inner surface 116 of the respective terminal isolator 80 to an (e.g., smooth and/or cylindrical) outer surface 118 of the respective terminal isolator 80.

Each terminal isolator 80 may be constructed from an electrically non-conductive material; e.g., an insulator material. Each terminal isolator 80, for example, may be constructed from glass or ceramic. The present disclosure, however, is not limited to the foregoing exemplary terminal isolator materials.

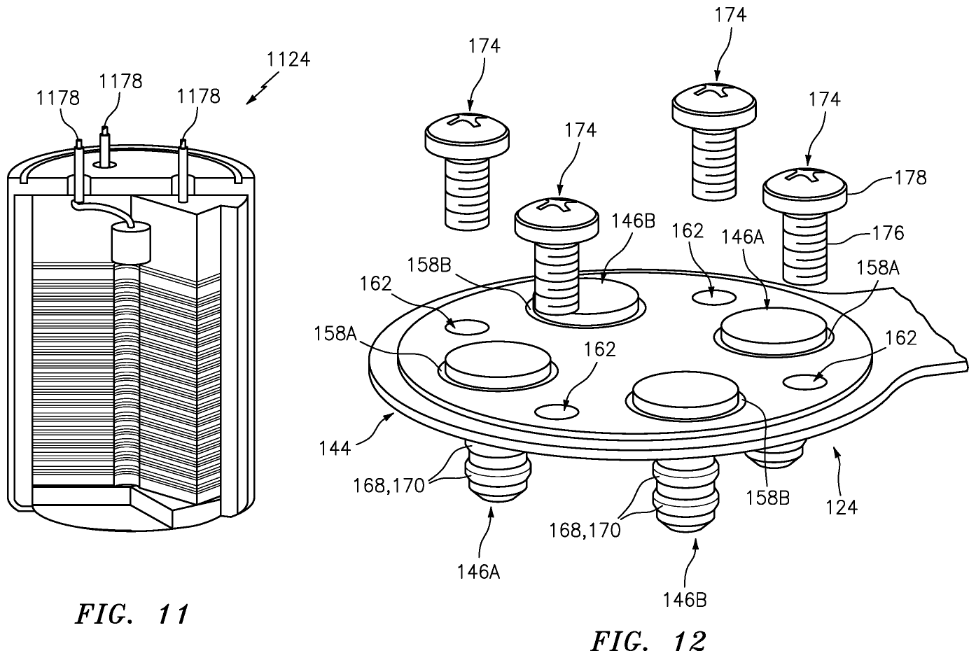

Referring to FIG. 10, each of the terminal isolators 80 is arranged within a respective one of the terminal apertures 60. Each terminal isolator 80 is connected to the battery header 34 via, for example, a mechanical fit (e.g., a slight interference fit) and/or a bonded connection. An exterior surface 120 of each terminal isolator 80 may be positioned to be flush with the battery header exterior surface 72. In other embodiments, however, the isolator exterior surface 120 may be longitudinally offset from the battery header exterior surface 72; e.g., the terminal isolator 80 may project out from the battery header 34 or be recessed into the terminal aperture 60.

Each of the battery terminals 78 is arranged within a respective one of the terminal apertures 60. More particularly, each terminal base 88 is arranged within a bore of a respective one of the terminal isolators 80. Each battery terminal 78 and its terminal base 88 are connected to the respective terminal isolator 80 via, for example, a mechanical fit (e.g., a slight interference fit) and/or a bonded connection. The terminal rim 90 is seated against the respective isolator exterior surface 120. With the foregoing arrangement, each battery terminal 78 and each respective terminal isolator 80 may form a hermetic seal with the battery header 34.

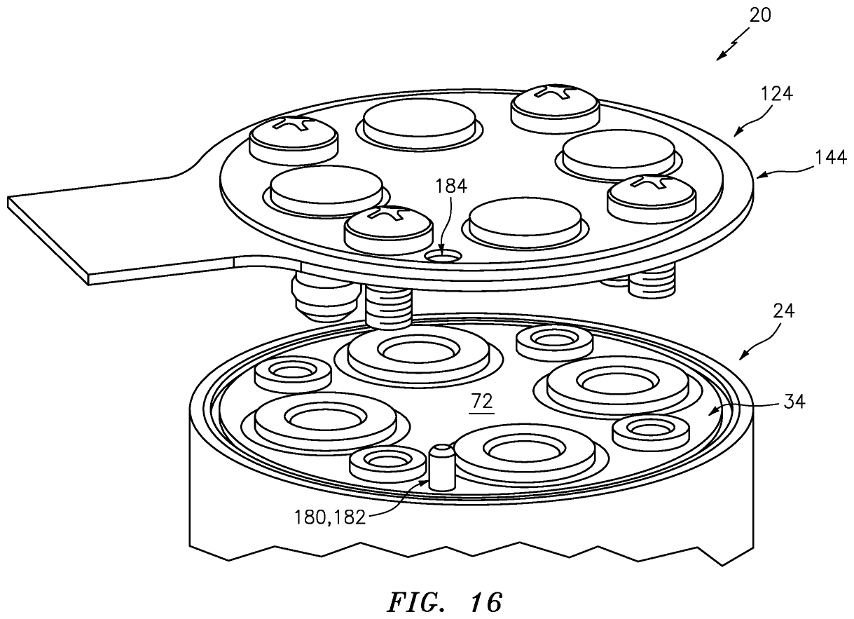

The exterior surface 96 of each battery terminal 78 is longitudinally displaced from the battery header exterior surface 72 by a second longitudinal distance 122. This second longitudinal distance 122 may be equal to or different (e.g., less) than the first longitudinal distance 76 (see FIG. 5). With such an arrangement, a plug 124 of the electrical harness 26 may be pressed against the battery header 34 without imparting undesirable stresses on the battery terminals 78 (e.g., see FIG. 15) as described below in further detail.

Each terminal base 88 may project longitudinally through the respective terminal isolator 80 and the respective terminal aperture 60 into the internal cavity 48. The terminal lead 92 is thereby located within the internal cavity 48 of the battery housing 28.

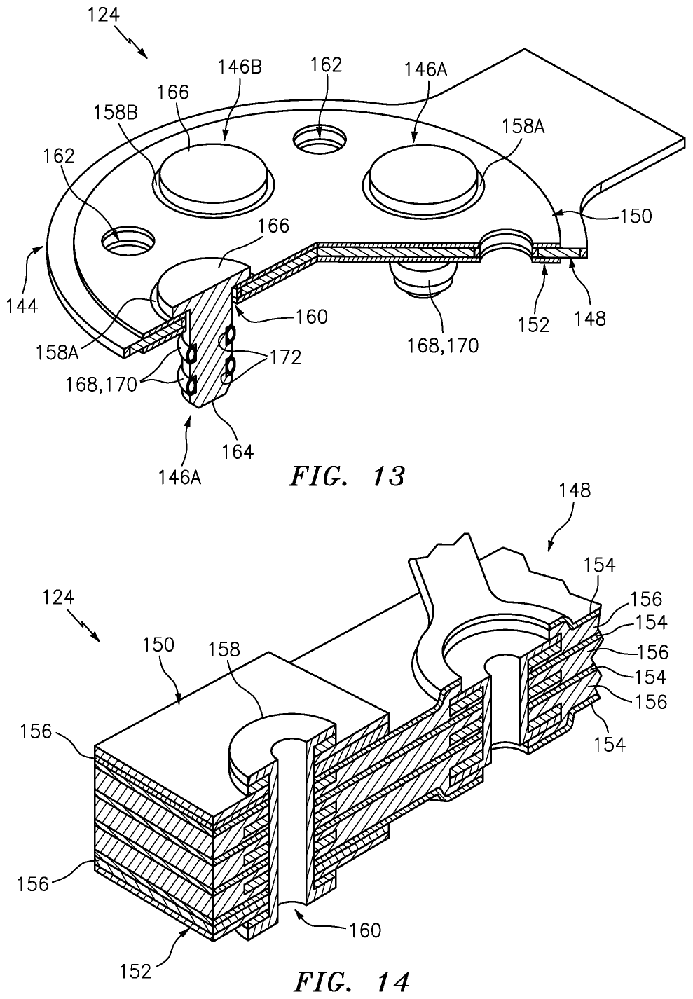

With the foregoing configuration, the battery terminals 78 and their receptacle apertures 94 are configured internal to the battery 24. These internal battery terminals 78 may thereby reduce the overall size/overall package of the battery 24 compared to, for example, a similar battery 1124 with external battery terminals 1178; e.g., see FIG. 11. Provision of the internal battery terminals 78 may in turn enable the battery 24 to be configured in a relatively small space, which may be particularly beneficial where the battery 24 is used, for example, in a mobile device application as described above. In addition, configuring the battery terminals 78 as internal battery terminals also reduces likelihood of damage to the battery terminals 78 due to, for example, improper handling.

Referring to FIG. 2, the battery cells 30 are arranged within the internal cavity 48. The battery 24 of FIG. 2 may be configured as a thermal battery. Each battery cell 30 of FIG. 2, for example, includes an anode 126 (e.g., an anode layer), a cathode 128 (e.g., a cathode layer) and solid electrolytic material 130 and 132. At least the solid electrolytic material 130 and 132 (and in some embodiments material of the anode 126 and/or material of the cathode 128) is configured to be melted by a heat source 134 (e.g., an igniter), which heat source 134 may also be arranged within the internal cavity 48. The melting of the electrolytic material 130 and 132 activates each battery cell 30 to provide a voltage. The battery cells 30 of FIG. 2 are arranged serially in a stack. However, in other embodiments, the battery cells 30 may be arranged in parallel with one another. The battery 24 is described above as a thermal battery for ease of description. The present disclosure, however, is not limited to thermal battery applications. For example, in other embodiments, the one or more battery cells 30 may be configured to provide an oxyhalide and silver zinc battery, etc.

The battery cells 30 of FIG. 2 are surrounded by insulation material 136. This insulation material 136 electrically and/or thermally insulates the battery cells 30 from the surrounding battery case 32 and battery header 34.

Referring to FIG. 1, each of the battery terminals 78 is electrically coupled to the one or more battery cells 30. The lead 92 of each of the battery terminals 78A (e.g., positive battery terminals), for example, is connected to at least one of the cathodes 128 (see FIG. 2) through an electrical connection 138 within the internal cavity 48. The lead 92 of each of the battery terminals 78B (e.g., negative battery terminals) is connected to at least one of the anodes 126 (see FIG. 2) through an electrical connection 140 within the internal cavity 48.

The electrical harness 26 of FIG. 1 includes the plug 124 and an electrical connector 142 (e.g., a cord, etc.). Referring to FIG. 12, the plug 124 may be configured as a flex harness. The plug 124 of FIG. 12, for example, includes a plug body 144 and one or more electrically conductive power pins 146A and 146B (generally referred to as “146”).

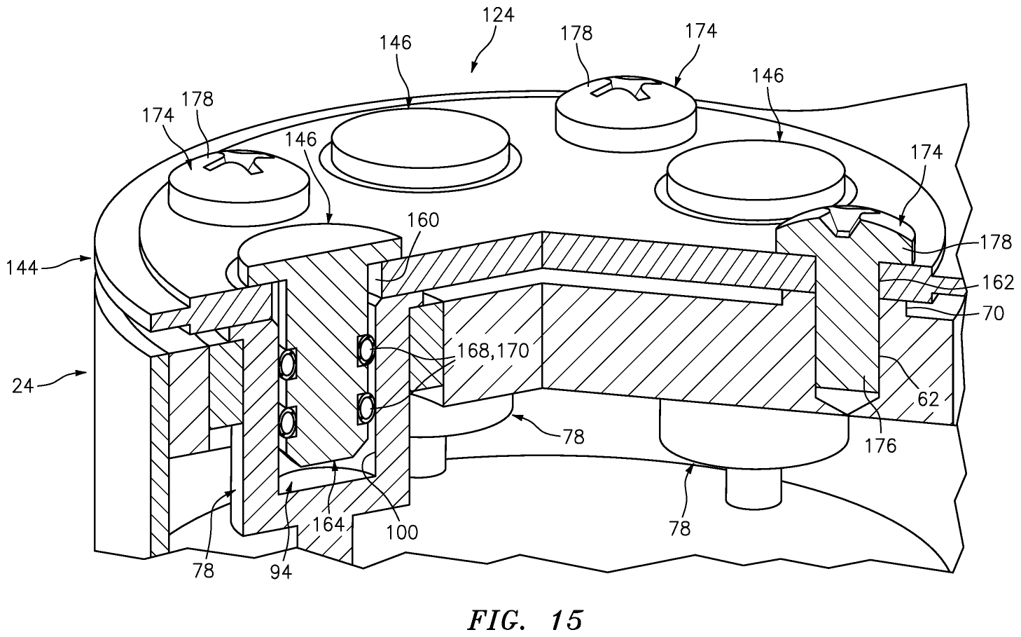

The plug body 144 may be configured with a generally bulbous geometry. Referring to FIG. 13, the plug body 144 includes an internal stack 148 sandwiched between a first reinforcement layer 150 and a second reinforcement layer 152. Referring to FIG. 14, the internal stack 148 includes one or more insulation layers 154 (e.g., Kapton® material layers) and one or more adhesive layers 156. The insulation layers 154 are interspersed with the adhesive layers 156 such that each adhesive layer 156 bonds together neighboring pairs of the insulation layers 154, or a respective insulation layer 154 with a neighboring reinforcement layer 150, 152. The internal stack 148 of FIG. 14 also includes one or more electrically conductive pads 158A and 158B (generally referred to as “158”) (e.g., copper (Cu) pads) electrically coupled with one or more electrically conductive traces, for example, embedded with the adhesive layers 156. The pads 158 form pin apertures 160 through the plug body 144. The traces provide electrically conductive paths for routing electricity from the pads 158 to the rest of the electrical harness 26 (see FIG. 1).

The plug body 144 of FIG. 12 also includes one or more mounting apertures 162 (e.g., smooth-wall through-holes). Each of these mounting apertures 162 extends through the plug body 144.

Each of the pins 146 of FIG. 13 are mated with a respective one of the pin apertures 160. More particularly, a shaft 164 of each pin 146 project through respective one of the pin apertures 160 and a head 166 of that pin 146 is seated against a respective one of the pads 158. Each pin 146 may be bonded (e.g., brazed) to the respective pad 158 and electrically coupled with the respective pad 158.

Each pin 146 of FIG. 13 is configured with one or more electrical couplers 168. Each electrical coupler 168 of FIG. 13 is configured as a (e.g., canted) coil spring 170. Each coil spring 170 extends circumferentially around and thereby circumscribes a respective one of the pins 146. Each coil spring 170 may be seated in a (e.g., annular) groove 172 in the shaft 164 of the respective pin 146. The electrical couplers 168 are thereby mechanically attached to the pin shafts 164.

Each pin and/or each electrical coupler 168 may be constructed from an electrically conductive material such as, but not limited to, metal. Each terminal pin and/or each electrical coupler 168, for example, may be constructed from nickel (Ni) and/or copper (Cu) coated steel. The present disclosure, however, is not limited to the foregoing exemplary pin and/or electrical coupler materials.

Referring to FIG. 15, when the plug 124 is mated with the battery 24, each pin 146 is mated with a respective one of the battery terminals 78. More particularly, the shaft 164 of each pin 146 projects longitudinally into a respective one of the receptacle apertures 94. Each electrical coupler 168 is pressed against and contacts a respective one of the surfaces 100, thereby electrically coupling the respective pin 146 to the respective battery terminal 78.

To maintain the plug 124 with the battery 24, one or more fasteners 174 (e.g., bolts, screws, etc.) are provided. Each of these fasteners 174 is mated with a respective one of the mounting apertures 162 in the plug 124 and a respective one of the mounting apertures 62 in the battery header 34. More particularly, a shaft 176 of each fastener 174 is inserted through the respective plug mounting aperture 162 and threaded into the respective header mounting aperture 62. Once each fastener 174 is tightened down, the plug body 144 is sandwiched between heads 178 of the fasteners 174 and the bosses 70. The fasteners 174 thereby removably secure the plug 124 to the battery header 34. In addition, because the plug 124 is pressed against the bosses 70, the plug 124 may exert relatively little if any longitudinal (e.g., compressive) pressure against the battery terminals 78. Furthermore, because the pins 146 are slidable mounted within the battery terminals 78, the pins 146 exert little if any longitudinal (e.g., compressive and/or tensile) pressure against the battery terminals 78. The plug 124 therefore may subject the battery terminals 78 to relatively low coupling stresses.

In some embodiments, referring to FIG. 16, the battery system 20 may be configured with at least one alignment feature 180. The battery header 34, for example, may include an alignment pin 182. This alignment pin 182 is connected to a base of the battery header 34. The alignment pin 182 of FIG. 16, for example, may be mated with (e.g., project into) a blind aperture in and attached (e.g., bonded, interference fit, etc.) to the base of the battery header 34. The alignment pin 182 projects longitudinally out from the battery header external surface 72. The alignment pin 182 of FIG. 16 is configured to mate with (e.g., project into) an alignment aperture 184 formed in and/or through the plug body 144. Such an alignment feature and alignment aperture pair may ensure the plug 124 can only be mated with the battery 24 according to the orientation of FIG. 16. While the alignment feature 180/the alignment pin 182 is shown in FIG. 16 as being configured with the battery header 34 and the alignment aperture 184 is shown as being configured with the plug body 144, the alignment feature 180/the alignment pin 182 may alternatively be configured with the plug body 144 and the alignment aperture 184 may alternatively be configured with the battery header 34.

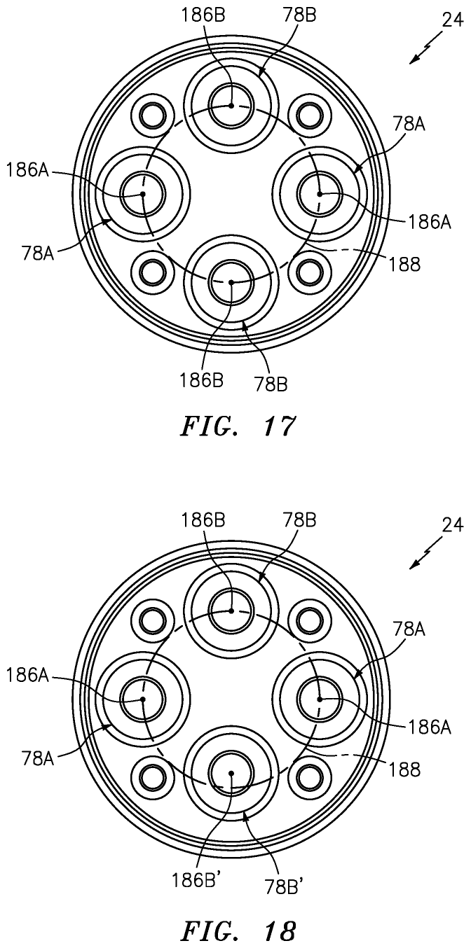

In some embodiments, referring to FIG. 17, a center 186A, 186B (generally referred to as “186”) of each of the battery terminals 78 is arranged along and aligned with (e.g., lays on) a circular, circumferential reference line 188. However, in other embodiments, the center 186 (e.g., 186B′) of at least one of the battery terminals 78 (e.g., 78B′) may alternatively be offset from the circumferential reference line 188 as shown in FIG. 18. Three of the battery terminal centers (e.g., 186A and 186B), for example, may be aligned with the circumferential reference line 188 and the remaining battery terminal center (e.g., 186B′) may be offset radially (e.g., inward) from the circumferential reference line 188. With such an arrangement, the plug 124 (see FIG. 15) can only be mated with the battery 24 according to a single orientation. The battery terminals 78 may thereby be arranged to provide an alignment feature.

Any one or more of the battery system components, such as but not limited to the battery case 32, the battery header 34, each battery terminal 78 and/or each battery pin 146, may be configured as a monolithic body or a non-monolithic body. Herein, the term “monolithic” may describe an apparatus which is formed as a single unitary body. The tubular sidewall 44, for example, may be cast, forged, machined, additively manufactured and/or otherwise formed with the end wall 46 as a single integral, unitary body. By contrast, the term “non-monolithic” herein may describe an apparatus which includes parts that are discretely formed from one another, where those parts are subsequently attached to one another. The tubular sidewall 44, for example, may be formed discretely from the end wall 46, and the end wall 46 may subsequently be bonded (e.g., welded, brazed, adhered, etc.), mechanically fastened and/or otherwise attached to the tubular sidewall 44.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. A battery system, comprising:
a battery case configured with an internal cavity;
a battery header attached to the battery case and enclosing the internal cavity, the battery header including a first terminal aperture and a second terminal aperture;
a first terminal connected to the battery header and arranged within the first terminal aperture, the first terminal configured with a first receptacle aperture; and
a second terminal connected to the battery header and arranged within the second terminal aperture, the second terminal configured with a second receptacle aperture.

2. The battery system of claim 1, wherein the first terminal projects through the first terminal aperture and into the internal cavity.

3. The battery system of claim 1, wherein the first receptacle aperture comprises a blind, smooth-walled bore.

4. The battery system of claim 1, wherein the first receptacle aperture extends partially into the first terminal from an exterior surface of the first terminal towards the internal cavity.

5. The battery system of claim 1, further comprising a first insulator arranged within the first terminal aperture between the battery header and the first terminal, the first insulator electrically isolating the first terminal from the battery header.

6. The battery system of claim 5, wherein
the first terminal extends longitudinally between an exterior end and an interior end, and the first terminal includes a base and a rim;
the base is arranged within the first terminal aperture, and the base extends longitudinally from the exterior end towards the interior end;
the rim is connected to and circumscribes the base at the exterior end, and the rim is seated against the first insulator; and
the first receptacle aperture extends from the exterior end partially into the base towards the interior end.

7. The battery system of claim 1, wherein a threaded fastener aperture extends partially into the battery header from an exterior surface of the battery header.

8. The battery system of claim 7, wherein
the battery header includes a boss that surrounds the threaded fastener aperture; and
an exterior surface of the first terminal is flush with or recessed from an exterior surface of the boss.

9. The battery system of claim 1, further comprising:
a plurality of battery cells arranged within the internal cavity, each of the plurality of battery cells including an anode, a cathode and electrolytic material;
the first terminal electrically coupled to the anode of at least one of the plurality of battery cells; and
the second terminal electrically coupled to the cathode of at least one of the plurality of battery cells.

10. The battery system of claim 1, further comprising:
a plug including a first pin and a second pin;
the first pin projecting into the first receptacle aperture and electrically coupled with the first terminal; and
the second pin projecting into the second receptacle aperture and electrically coupled with the second terminal.

11. The battery system of claim 10, further comprising a fastener removably securing the plug to the battery header.

12. The battery system of claim 10, further comprising:
an alignment feature configured to mate with an alignment aperture to align the plug with the battery header;
the alignment feature configured with one of the plug and the battery header.

13. The battery system of claim 10, wherein
the plug further includes a first coil spring wrapped around the first pin; and
the first coil spring is between and electrically couples the first pin and the first terminal.

14. The battery system of claim 13, wherein the first coil spring is seated within a groove in the first pin.

15. The battery system of claim 1, further comprising:
a third terminal connected to the battery header and arranged within a third terminal aperture in the battery header, the third terminal configured with a third receptacle aperture;
a center of the first terminal and a center of the second terminal arranged along and aligned with a circumferential reference line; and
a center of the third terminal arranged along and offset from the circumferential reference line.

16. A battery system, comprising:
a battery case configured with an internal cavity;
a battery header attached to the battery case and enclosing the internal cavity, the battery header including a first terminal aperture;
a first terminal connected to the battery header and arranged within the first terminal aperture, the first terminal configured with a blind first receptacle aperture; and
one or more battery cells arranged within the internal cavity, each of the one or more battery cells including a cathode, an anode and electrolytic material, wherein the first terminal is electrically coupled to one of the cathode and the anode of at least one of the one or more battery cells.

17. The battery system of claim 16, further comprising a second terminal connected to the battery header and arranged within a second terminal aperture in the battery header, the second terminal configured with a blind second receptacle aperture.

18. The battery system of claim 16, further comprising:
a plug including a first pin that projects into the blind first receptacle aperture and is electrically coupled with the first terminal; and
a fastener removably securing the plug to the battery header.

19. A battery system, comprising:
a battery including a first terminal configured with a first receptacle aperture;
a plug including a first pin that projects into the first receptacle aperture and is electrically coupled with the first terminal; and
a fastener securing the plug to the battery.

20. The battery system of claim 19, wherein
the battery further includes a second terminal configured with a second receptacle aperture; and
the plug further includes a second pin that projects into the second receptacle aperture and is electrically coupled with the second terminal.
